(19) United States
(12) Patent Application Publication
(10) Pub. No.: US 2018/0157387 A1
(43) Pub. Date: Jun. 7, 2018

(54) Operation Interface And Operation Method Of Mobile Terminal

(71) Applicants: Inventec (Pudong) Technology Corporation, Shanghai (CN); Inventec Corporation, Taipei City (TW)

(72) Inventors: Jing Zhou, Shanghai (CN); Yan Li Mao, Shanghai (CA)

(21) Appl. No.: 15/623,078

(22) Filed: Jun. 14, 2017

(30) Foreign Application Priority Data
Dec. 7, 2016 (CN) 201611114133.7

(51) Int. Cl. G06F 3/0482; H04M 1/725; G06F 17/21; G06F 3/0484

(52) U.S. Cl. CPC G06F 3/0482; H04M 1/72519; G06F 3/04883; G06F 3/04845; G06F 17/218

(57) ABSTRACT

The present disclosure illustrates an operation interface and an operating method of a mobile terminal. In the operation interface, after a first tag group is displayed and a first tag among the first tag group is selected, the first tag group and a second tag group, which belongs to a lower hierarchical level than the first tag group and associated with the selected first tag, are displayed, so as to make all second tags associated with the selected first tag, be shown on a touch screen at the same time, to provide a user to click without switching the pages and operating the pop-up box, thereby reducing the number of operations, and improving the user experience of the user.

### CROSS-REFERENCE TO RELATED APPLICATION

This application claims the benefit of Chinese Patent Application No. 201611114133.7, filed Dec. 7, 2016.

### BACKGROUND OF THE INVENTION

### 1. Field of the Invention

The present disclosure relates to an operation interface and an operation method, more particularly to an operation interface and an operation method of a mobile terminal.

### 2. Description of the Related Art

In recent years, with rapid development of touch technology, a user may use finger or other object to touch or press a touch screen, or slide on a touch screen to operate a mobile terminal.

In general, applications of mobile terminal are usually subject to a limited area of an operation interface, and when the user is to perform hierarchical and associated selection, the mobile terminal usually shows a pop-up box for the user to perform selection. However, if the pop-up box includes a lot of options, the user must operate scroll to browse all options, and it makes the options not intuitive enough.

For this reason, some manufacturers develop an operation method of clicking icon and then switching page to perform the hierarchical and associated selection, so that the options become more intuitive. However, this operation method requires the user to continuously and repeatedly switch pages, so there is still a problem that the number of operation is too many and the operation becomes slow and inconvenient.

As a result, what is need is to develop an operation interface and an operation method to solve the problem that the number of operation is too many and the operation becomes slow and inconvenient.

### SUMMARY OF THE INVENTION

In order to solve the problem, the present disclosure is to provide an operation interface and an operation method of a mobile terminal.

According to an embodiment, the present disclosure provides an operation interface of a mobile terminal, and the operation interface includes a storage unit, a touch display unit and a processing unit. The storage unit is configured to store a first tag group and a second tag group which belongs to a lower hierarchical level than the first tag group. The touch display unit is configured to display the first tag group, and sense a first input signal and at least one second input signal. The processing unit is electrically coupled to the storage unit and the touch display unit. When the touch display unit senses the first input signal, the processing unit executes a determination procedure according to the first input signal, to select a first tag from the first tag group, and the touch display unit displays the first tag group and the second tag group which is associated with the selected first tag. When the touch display unit senses the at least one second input signal, the processing unit executes other determination procedure according to the at least one second input signal, to select at least one second tag from the second tag group.

According to an embodiment, the present disclosure provides an operation method of a mobile terminal, and the operation method includes following steps: displaying a first tag group; sensing a first input signal to select a first tag from the first tag group; displaying the first tag group and a second tag group which belongs to a lower hierarchical level than the first tag group and associated with the selected first tag; and sensing at least one second input signal to select at least one second tag from the second tag group.

According to above content, the difference between the present disclosure and the conventional technology is that, in the operation interface and operation method of the present disclosure, the first tag group is displayed first, and after the first tag of the first tag group is selected, the first tag group and the second tag group which is associated with the selected first tag and belongs to the lower hierarchical level than the first tag group are displayed.

By using above technical means, all second tags associated with the selected first tag are loaded into the touch screen for the user to click without switching page and operating the pop-up box, so that the effect of reducing the number of operation and improving the user experience may be achieved.

### BRIEF DESCRIPTION OF THE DRAWINGS

The structure, operating principle and effects of the present disclosure will be described in detail by way of various embodiments which are illustrated in the accompanying drawings.

FIG. 1 is a block diagram of an operation interface of a mobile terminal, in accordance with the present disclosure.

FIG. 2 is a flowchart showing the steps in an operation of an operation method of the mobile terminal, in accordance with the present disclosure.

FIG. 3 is a flowchart showing the steps in an operation of the operation method for adaptively adjusting the operation interface of the mobile terminal, in accordance with the present disclosure.

FIG. 4 is a schematic view of the mobile terminal using the operation interface of the present disclosure.

FIG. 5 is a schematic view of an embodiment of a hierarchical database stored in the mobile terminal shown in FIG. 4.

FIGS. 6A through 6F are schematic views of display screen of operative steps of an embodiment of the operation interface of the mobile terminal of the present disclosure.

### DETAILED DESCRIPTION OF THE PREFERRED EMBODIMENTS

The following embodiments of the present invention are herein described in detail with reference to the accompanying drawings. These drawings show specific examples of the embodiments of the present invention. It is to be understood that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be understood that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present invention. As used herein, the term “or” includes any and all combinations of one or more of the associated listed items.

The term defined in the present disclosure is illustrated before description of an operation interface and an operation method of the mobile terminal, in accordance with the present disclosure. The mobile terminal described in the present disclosure may be a mobile device, such as a smart phone, a tablet computer, a hand-held computer, a mobile internet device (MID) or a personal digital assistant (PDA).

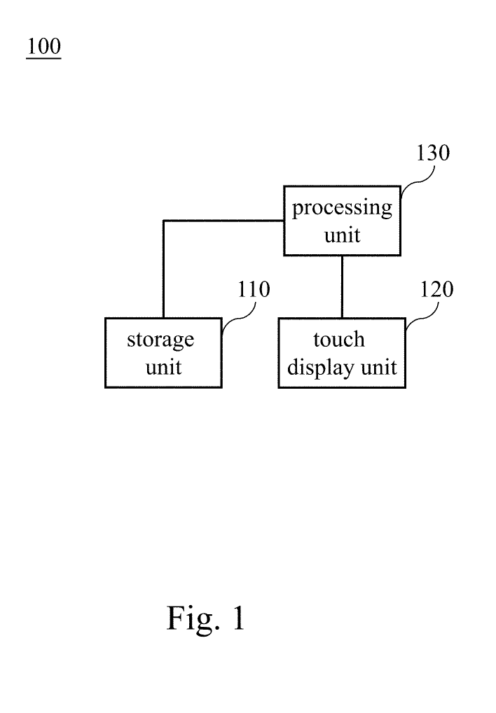

The following describes the operation interface and the operation method of the mobile terminal of the present disclosure with reference to the accompanying drawings. FIG. 1 is a block diagram of the operation interface of the mobile terminal of the present disclosure, and the operation interface 100 includes a storage unit 110, a touch display unit 120 and a processing unit 130. The processing unit 130 is electrically coupled to the storage unit 110 and the touch display unit 120. The storage unit 110 is configured to store a first tag group and a second tag group which belongs to a lower hierarchical level than the first tag group. In greater detail, the first tag group includes a plurality of first tags, and the second tag group includes a plurality of second tags, and the hierarchical level of the first tag group is higher than that of the second tag group. According to association attributes of the plurality of second tags, the plurality of second tags having the same association attribute are categorized to the same first tag. In other words, a relationship between the first tag and the second tag may be a relationship between a parent tag and a child tag, that is, the storage unit 110 includes a hierarchical database having a tree structure, and the hierarchical database includes the first tag group and the second tag group which belongs to the lower hierarchical level than the first tag group. In actual implementation, the storage unit 110 may be RAM memory, but the present disclosure is not limited thereto.

The touch display unit 120 is configured to display the first tag group, and sense a first input signal and at least one second input signal. In actual implementation, the touch display unit 120 may be, but not limited to, a capacitive touch screen or a resistive touch screen, and the first input signal and the second input signal are signals respectively generated by the touch screen when the user touches or presses the touch screen by finger or other object. Furthermore, the touch display unit 120 may be a single-touch device or a multi-touch device.

When the touch display unit 120 senses the first input signal, the processing unit 130 executes a determination procedure according to the first input signal, to select the first tag from the first tag group, thereby enabling the touch display unit 120 to display the first tag group and the second tag group, wherein the second tag group is associated with the selected first tag. Based on the first input signal sensed by the touch display unit 120, the determination procedure reckons which first tag of the first tag group is clicked by the user.

When the touch display unit 120 senses the at least one second input signal, the processing unit 130 executes other determination procedure according to the at least one second input signal, to select at least one second tag from the second tag group. According to the at least one second input signal sensed by the touch display unit 120, the other determination procedure reckons which second tag or second tags of the second tag group is/are clicked by the user. For example, suppose that the touch display unit 120 is the single-touch device and displays the first tag group and the second tag group, and when the touch display unit 120 sense the second input signal, the processing unit 130 may reckon which second tag of the second tag group is clicked by the user (that is, the user only selects single second tag once), according to the second input signal sensed by the touch display unit 120; when the touch display unit 120 displays the first tag group and the second tag group and senses two second input signals, the processing unit 130 reckons which two second tags are clicked by the user (that is, the user may select two second tags once), according to the two second input signals sensed by the touch display unit 120. The two second input signals may be generated when the user respectively clicks the two second tag in sequential order, but the present disclosure is not limited thereto, and the cause of two second input signals may be adjusted upon actual situation. In other words, when the touch display unit 120 is the multi-touch device, the processing unit 130 may reckon which second tag or second tags of the second tag group is/are clicked by the user, according to the second input signal sensed by the touch display unit 130. The operation manner of the multi-touch device or the single touch device is well known by one of ordinary skill in the art, so the detailed description is not repeated.

In the operation interface of the mobile terminal of the present disclosure, the first tag group and the second tag group may be visually prompted by different color, or be displayed by different rows in a sequential order, for being distinguished. Furthermore, in order to highlight the selected first tag and second tag, the selected first tag and the selected second tag may be visually prompted by color for indication. Furthermore, according to a size and a resolution of a touch screen of the touch display unit 120, the operation interface of the mobile terminal of the present disclosure may adaptively adjust the display of the operation interface by a fluid layout. The actual executive steps will be described below.

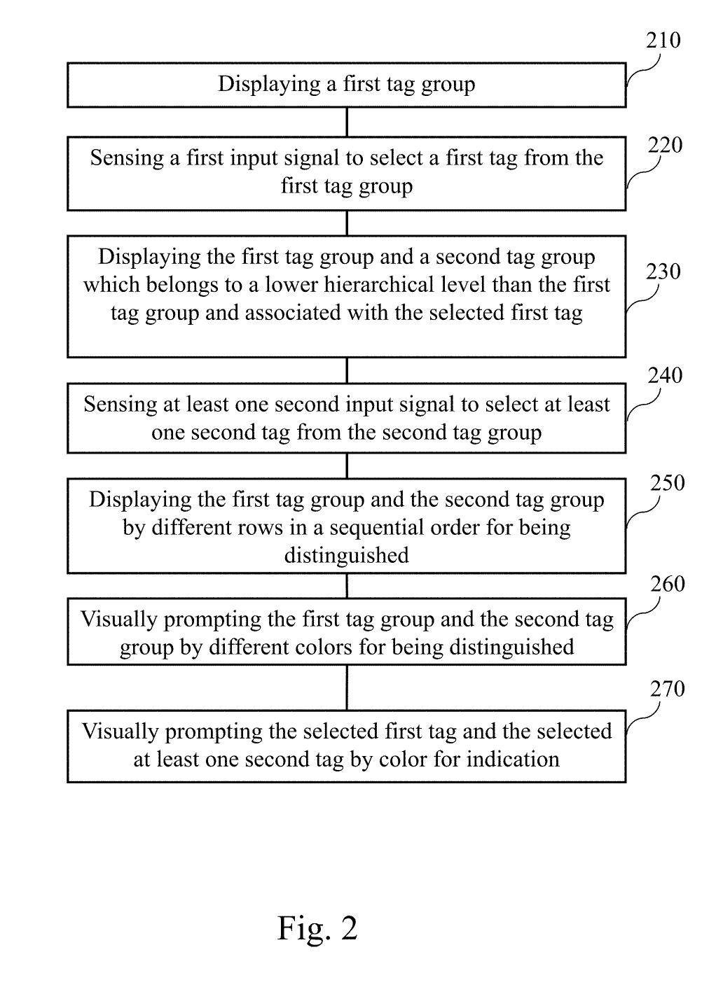

The following refers to FIG. 2, which is a flowchart showing the steps in the operation method of the mobile terminal of the present disclosure. The operation method includes steps below. In a step 210, a first tag group is displayed. In a step 220, a first input signal is sensed, so that a first tag of the first tag group is selected according to the first input signal. In a step 230, the first tag group and a second tag group are displayed, and the second tag group belongs to the lower hierarchical level than the first tag group, and is associated with the selected first tag. In a step 240, at least one second input signal is sensed, and at least one second tag of the second tag group is selected according to the at least one second input signal. Through aforementioned steps, after the first tag group is displayed and the first tag of the first tag group is selected, the first tag group and the second tag group associated with the selected first tag and belongs to the lower hierarchical level than the first tag group are displayed, so that all second tags associated to the selected first tag are loaded into the touch screen for user to click. As a result, the user does not need to switch page and operate pop-up box, and it may reduce the number of the operation and improve user experience.

In order to distinguish the first tag group from the second tag group, the operation method of the mobile terminal may further include steps 250 and 260. In the step 250, the first tag group and the second tag group are displayed by different rows in the sequential order for being distinguished easily. In the step 260, the first tag group and the second tag group are visually prompted by different colors for being distinguished. Furthermore, in order to highlight the selected first tag and the selected second tag, the operation method of the mobile terminal may further include a step 270. In the step 270, the selected first tag and the selected at least one second tag are visually prompted by different color. The execution order of the steps of the present disclosure is not limited unless a cause-effect relation between two steps exists.

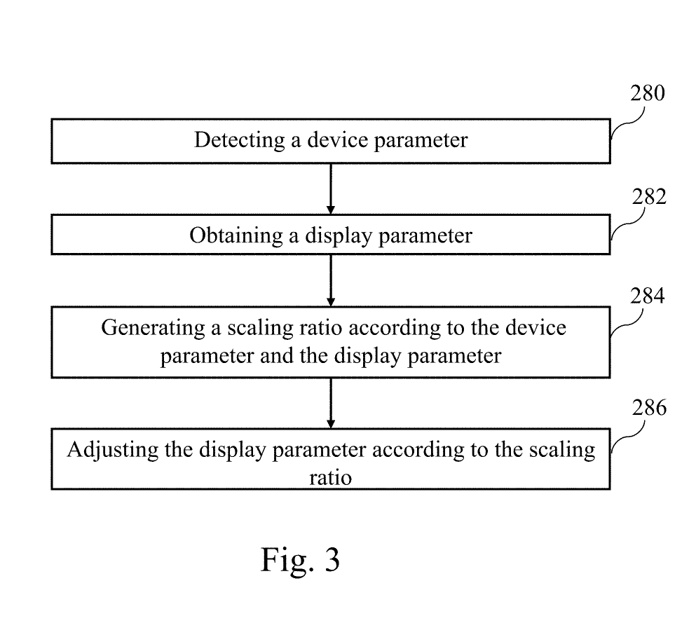

The following refers to FIG. 3, which is a flowchart showing the steps in an operation of adaptively adjusting the operation interface of the operation method of the mobile terminal of the present disclosure. According to a size and a resolution of the touch screen of the touch display unit, the operation interface may be adaptively adjusted for display by using a fluid layout, and the operation method of the mobile terminal may further include following steps. In a step 280, a device parameter is detected. In a step 282, a display parameter is obtained; in a step 284, a scaling ratio is generated according to the device parameter and the display parameter; in a step 286, the display parameter is adjusted according to the scaling ratio. Preferably, the device parameter may be, but not limited to, a resolution of the touch display unit; and the display parameter may be, but not limited to, a resolution of display screen of the operation interface; and the scaling ratio may be, but not limited to, a scaling ratio of a width or a height, and adjustable upon practical demand. Through aforementioned steps, the operation interface may be flexibly used on different mobile terminals.

Aforementioned illustration of the operation interface and the operation method of the mobile terminal of the present disclosure is merely for the hierarchical database including the first tag group and the second tag group which belongs to the lower hierarchical level than the first tag group (that is, the hierarchical database has the two-level tree structure). However, the operation interface and the operation method of the mobile terminal of the present disclosure may also be applied to the hierarchical database with N-level tree structures, and N is a positive integer higher than or equal to 2. It should be noted that only the tag group at the last level may be selected singly or multiply. For example, in aforementioned illustration of the operation interface and the operation method of the present disclosure applied with the hierarchical database having the two-level tree structure, the at least one second tag of the second tag group may be selected.

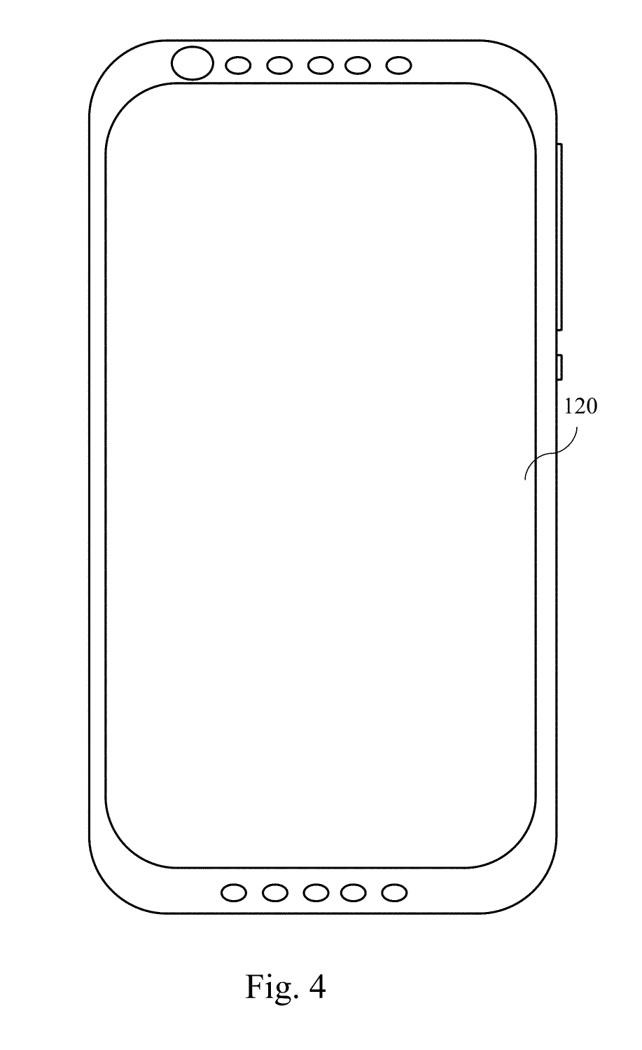

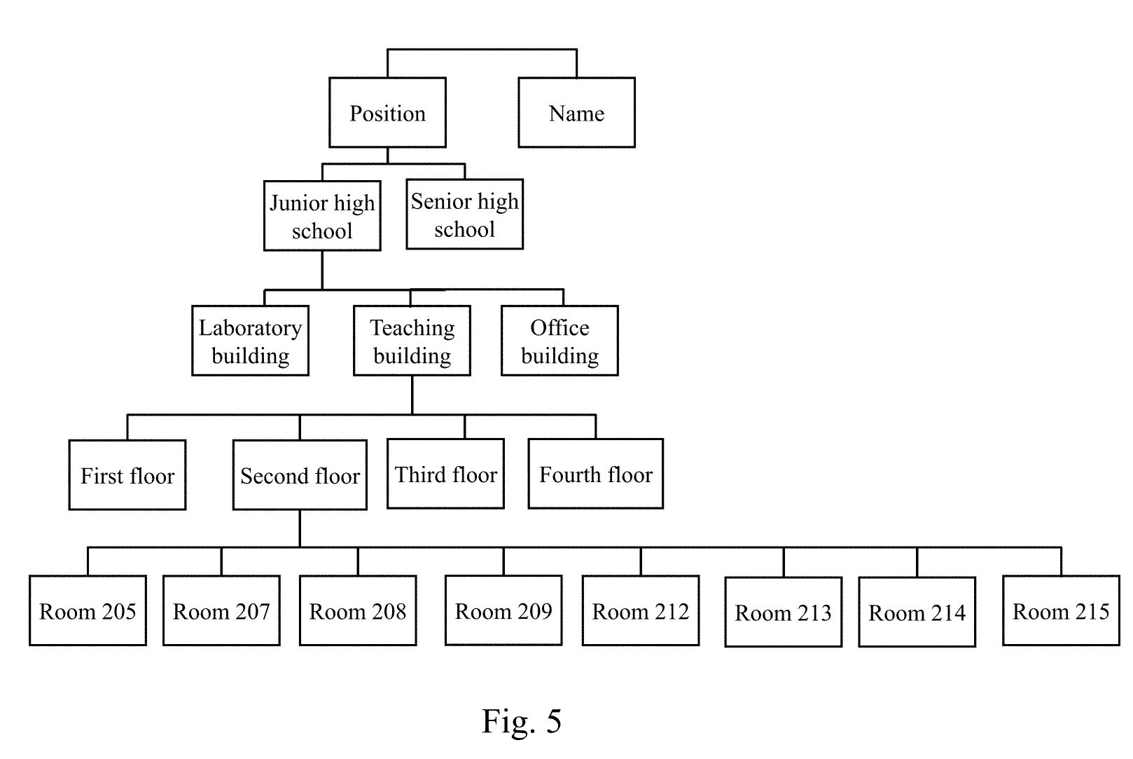

The following refers to an embodiment in which the operation interface and the operation method of the mobile terminal of the present disclosure are applied with a hierarchical database having a five-level tree structure, and the embodiment will be illustrated in cooperation with FIGS. 4 through 6F. FIG. 4 is a schematic view of the mobile terminal having the operation interface of the present disclosure. In this embodiment, the mobile terminal having the operation interface of the present disclosure may be a smartphone, and the storage unit may be RAM, the touch display unit may be a single-touch capacitive touch screen, the processing unit may be a micro-processor. FIG. 5 is a schematic view of an embodiment of the hierarchical database stored in the storage unit of the mobile terminal of FIG. 4.

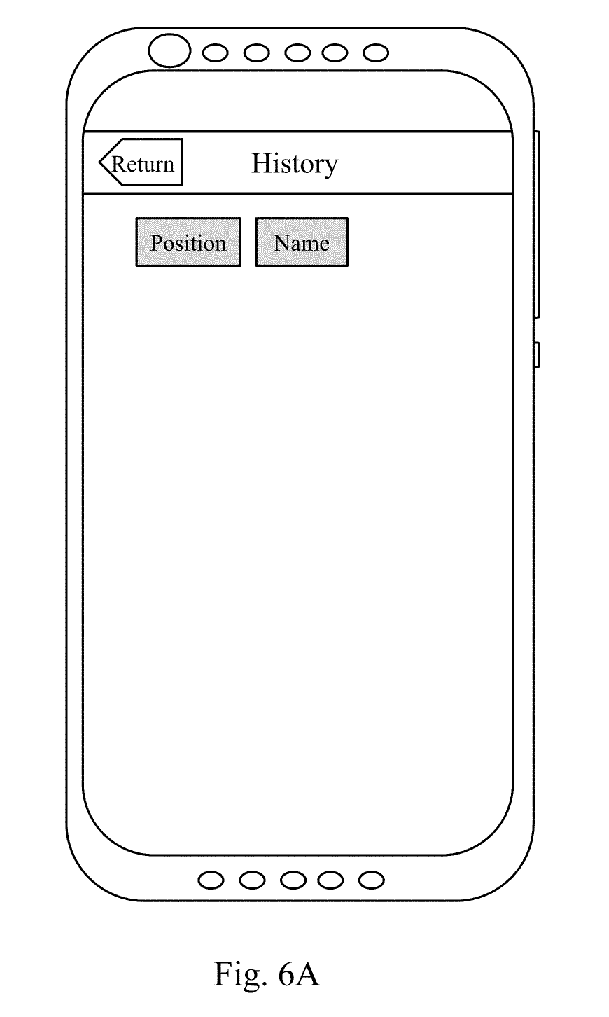

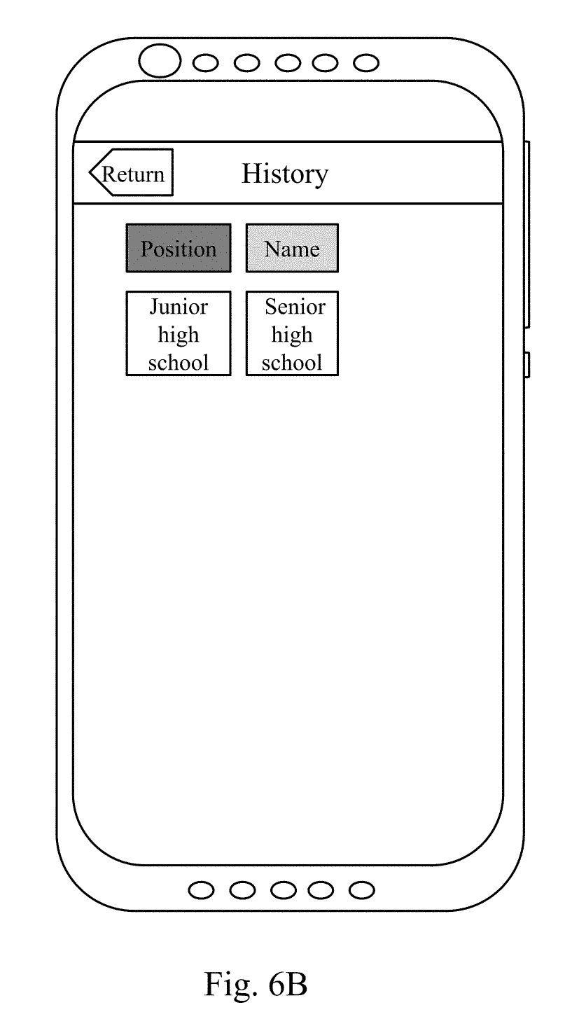

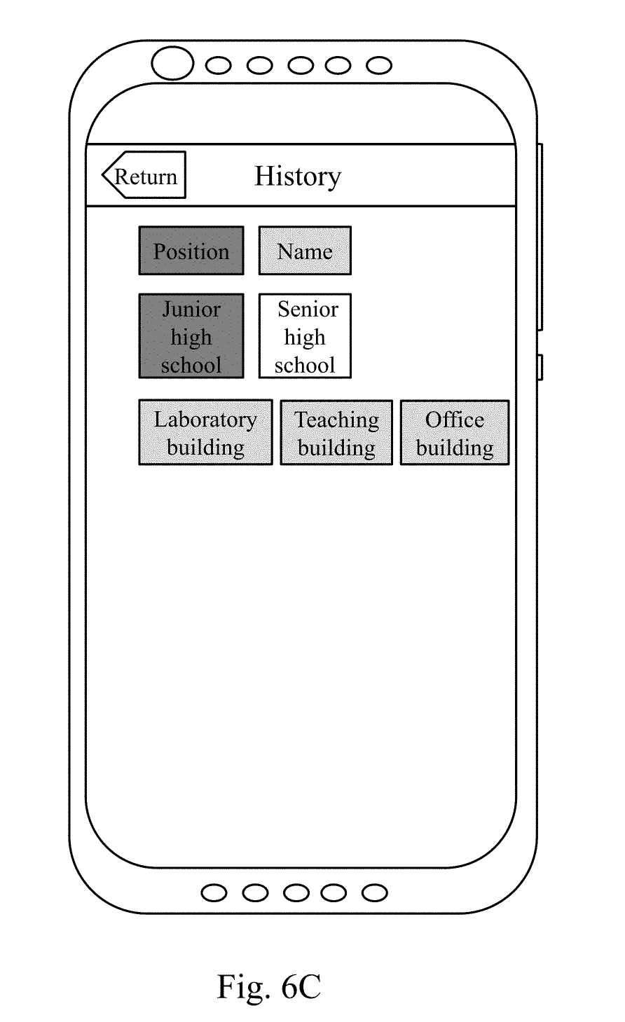

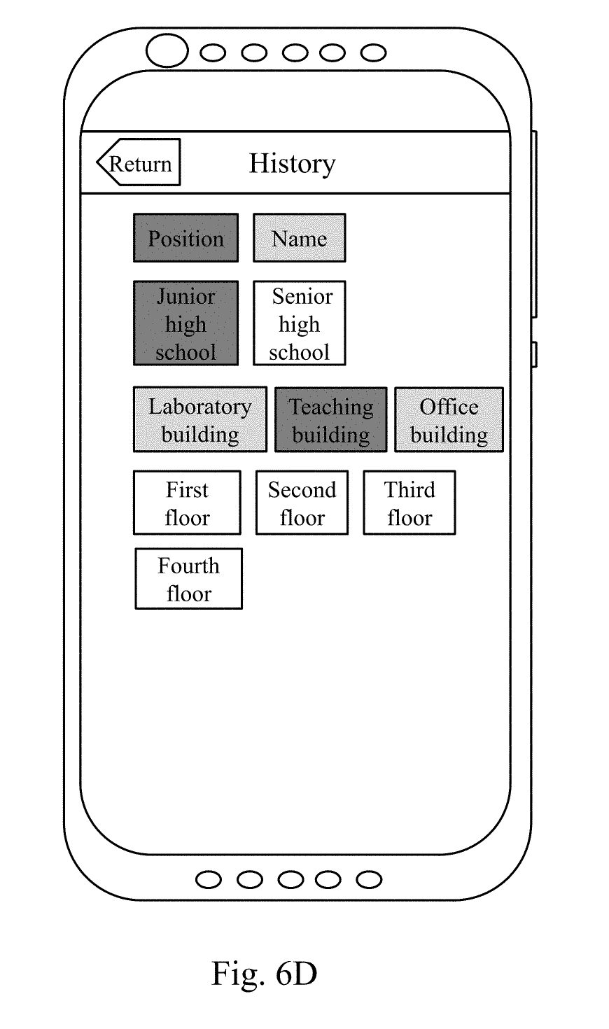

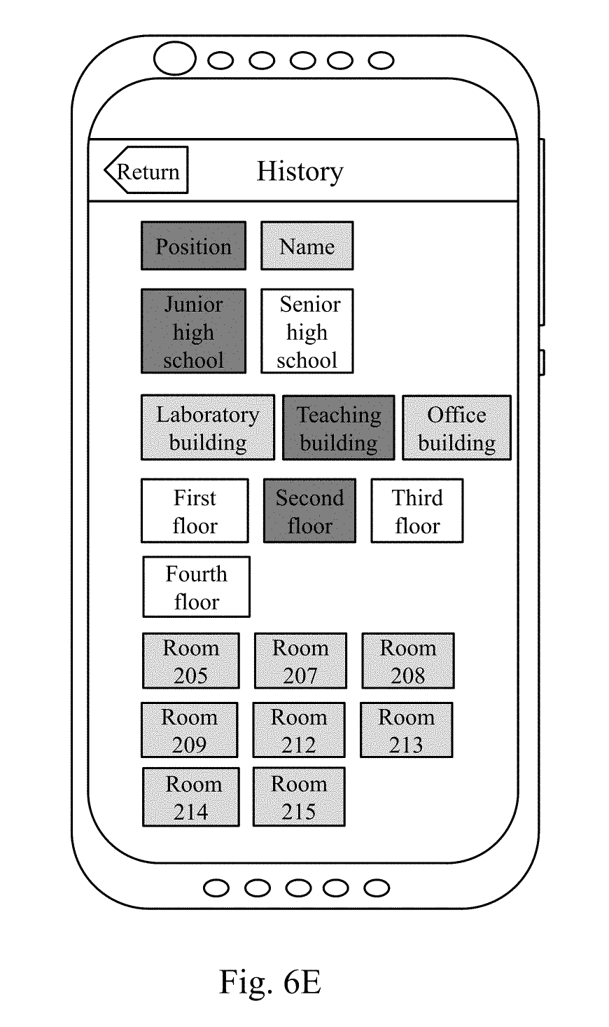

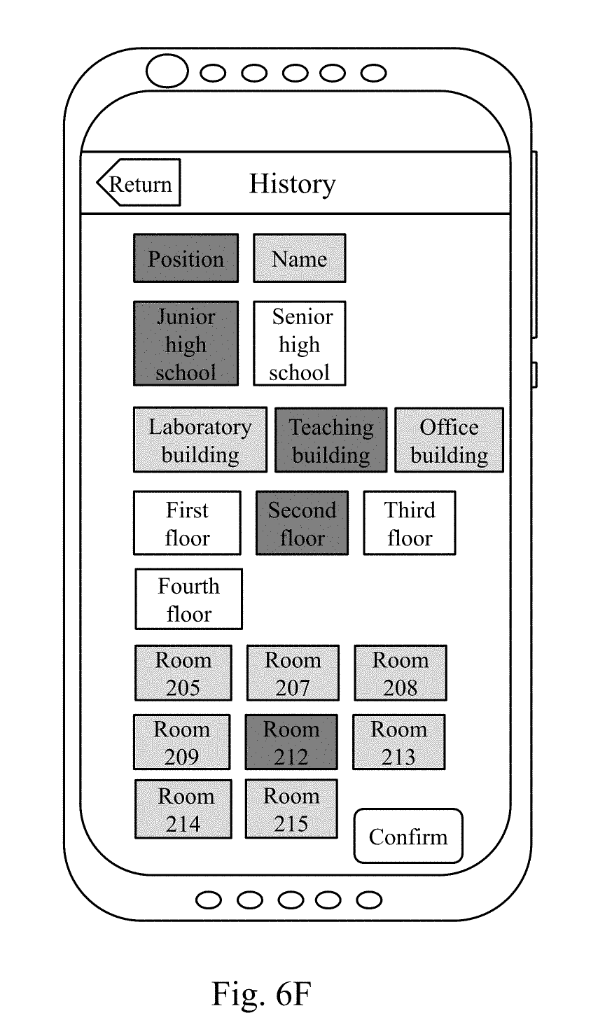

In this embodiment, when a user wants to know the information about a room 212 at second floor of a teaching building of a junior high school, the user needs to click a “Position” tag, a “Junior high school” tag, a “Teaching building” tag, a “Second floor” tag, and a “Room 212” tag in sequential order, and the screen image displayed on the touch display unit are shown as FIGS. 6A through 6F, which are schematic views of the screen images of the operational steps of the an embodiment of operation interface of the mobile terminal of the present disclosure.

As shown in FIG. 6A, in this embodiment, the first tag group includes two first tags, one is the “Position” tag, and the other is a “Name” tag. In this step, the capacitive touch screen displays the first tag group.

As shown in FIG. 6B, in this embodiment, the user's finger touches the “Position” tag of the first tags, so the selected “Position” tag is highlighted by a color other than the non-selected “Name” tag; the “Junior high school” tag and a “Senior high school” tag of the second tag group are associated with the “Position” tag, so the “Junior high school” tag and the “Senior high school’ tag of the second tag group are displayed on the screen for the user to click after the “Position” tag is selected. The first tag group and the second tag group are displayed by different colors (that is, the color of the first tag group is darker than that of the second tag group) and by different rows in order, for being distinguished.

As shown in FIG. 6C, in this embodiment, the user's finger touches the “Junior high school” tag of the second tag group, so the selected “Junior high school” tag is displayed by a color other than the non-selected “Senior high school” tag; and, a “Laboratory building” tag, a “Teaching building” tag and a “Office building” of a third tag group are associated with the selected “Junior high school” tag, so the “Laboratory building” tag, the “Teaching building” tag and the “Office building” of the third tag group are displayed on the screen for the user to click after the “Junior high school” tag of the second tag group is selected. The second tag group and the third tag group are displayed by different colors (that is, the color of the second tag group is lighter than that of the third tag group) and by different rows in sequential order for being distinguished.

As shown in FIG. 6D, in this embodiment, the user's finger touches the “Teaching building” tag, so the selected “Teaching building” tag is displayed by a color other than the non-selected “Laboratory building” tag and the “Office building” tag of the third tag group; and, a “First floor” tag, a “Second floor” tag, a “Third floor” tag, and a “Fourth floor” tag of a fourth tag group are associated with the selected “Teaching building” tag, so the “First floor” tag, the “Second floor” tag, the “Third floor” tag, and the “Fourth floor” tag of the fourth tag group are displayed on the screen for the user to click after the “Teaching building” tag of the third tag group is selected. The third tag group and the fourth tag group are displayed by different colors (that is, the color of the third tag group is darker than that of the fourth tag group) and by different rows in a sequential order for being distinguished.

As shown in FIG. 6E, in this embodiment, the user's finger touches the “Second floor” tag of the fourth tag group, so the selected “Second floor” tag is displayed by a color other than the non-selected “First floor” tag, the “Third floor” tag and the “Fourth floor” tag; and, a “Room 205” tag, a “Room 207” tag, a “Room 208” tag, a “Room 209” tag, a “Room 212” tag, a “Room 213” tag, a “Room 214” rag and a “Room 215” tag of the fifth tag group are associated with the selected “Second floor” tag of the fourth tag group, so the “Room 205” tag, the “Room 207” tag, the “Room 208” tag, the “Room 209” tag, the “Room 212” tag, the “Room 213” tag, the “Room 214” rag and the “Room 215” tag of the fifth tag group are displayed on the screen for the user to click after the “Second floor” tag of the fourth tag group is selected. The fourth tag group and the fifth tag group are displayed by different colors (that is, the color of the fourth tag group is lighter than that of the fifth tag group) and by different rows in sequential order for being distinguished.

As shown in FIG. 6F, in this embodiment, the user's finger touches the “Room 212” tag of the fifth tag group, so the “Room 212” tag is displayed by a color other than the non-selected “Room 205” tag, the “Room 207” tag, the “Room 208” tag, the “Room 209” tag, the “Room 213” tag, the “Room 214” tag, and the “Room 215” tag. Finally, the user clicks a “confirm” virtual button, the information about the room 212 may be displayed on the screen.

To summarize, the difference between the present disclosure and the conventional technology is that, in the operation interface and operation method of the present disclosure, the first tag group is displayed first, and after the first tag of the first tag group is selected, the first tag group and the second tag group which is associated with the selected first tag and belongs to the lower hierarchical level than the first tag group are displayed, and all second tags associated with the selected first tag are displayed on the touch screen. By using above technical means, the conventional technology problem may be solved, and the technical effect of enabling the user to click the tag more intuitively without switching page and operating the pop-up box, reducing the number of operation, and improving the user experience, may be achieved.

The present disclosure disclosed herein has been described by means of specific embodiments. However, numerous modifications, variations and enhancements can be made thereto by those skilled in the art without departing from the spirit and scope of the invention set forth in the claims.

What is claimed is:

1. An operation interface of a mobile terminal, comprising:
a storage unit configured to store a first tag group and a second tag group which belongs to a lower hierarchical level than the first tag group;
a touch display unit configured to display the first tag group, and sense a first input signal and at least one second input signal; and
a processing unit electrically coupled to the storage unit and the touch display unit;
wherein, when the touch display unit senses the first input signal, the processing unit executes a determination procedure according to the first input signal, to select a first tag from the first tag group, and the touch display unit displays the first tag group and the second tag group which is associated with the selected first tag;
wherein when the touch display unit senses the at least one second input signal, the processing unit executes other determination procedure according to the at least one second input signal, to select at least one second tag from the second tag group.

2. The operation interface of according to claim 1, wherein the first tag group and the second tag group are visually prompted by different colors for being distinguished.

3. The operation interface according to claim 1, wherein the selected first tag and the selected at least one second tag are visually prompted by different colors for indication.

4. The operation interface according to claim 1, wherein the first tag group and the second tag group are displayed by different rows in a sequential order for being distinguished.

5. The operation interface according to claim 1, wherein the processing unit detects a device parameter of the touch display unit to obtain a display parameter, and generates a scaling ratio according to the device parameter and the display parameter, and adjusts the display parameter according to the scaling ratio.

6. An operation method of a mobile terminal, comprising:
displaying a first tag group;
sensing a first input signal to select a first tag from the first tag group;
displaying the first tag group and a second tag group which belongs to a lower hierarchical level than the first tag group and associated with the selected first tag; and
sensing at least one second input signal to select at least one second tag from the second tag group.

7. The operation method according to claim 6, further comprising:
displaying the first tag group and the second tag group by different rows in a sequential order for being distinguished.

8. The operation method according to claim 6, further comprising:
visually prompting the first tag group and the second tag group by different colors for being distinguished.

9. The operation method according to claim 6, further comprising:
visually prompting the selected first tag and the selected at least one second tag by color for indication.

10. The operation method according to claim 6, further comprising:
detecting a device parameter;
obtaining a display parameter;
generating a scaling ratio according to the device parameter and the display parameter; and
adjusting the display parameter according to the scaling ratio.
